(19) United States
(12) Patent Application Publication
(10) Pub. No.: US 2026/0197413 A1
(43) Pub. Date: Jul. 9, 2026

(54) MOBILE UNIT FOR CERTIFIABLE DIGITIZATION OF DOCUMENTS

(71) Applicant: CSA SOCIETÀ CONSORTILE PER AZIONI, ROMA (IT)

(72) Inventor: Antonio CAMPANILE, ROMA (RM) (IT)

(21) Appl. No.: 19/133,685

(22) PCT Filed: Nov. 22, 2023
(86) PCT No.: PCT/IB2023/061802

§ 371 Date: May 28, 2025

(30) Foreign Application Priority Data
Nov. 30, 2022 (IT) 102022000024657

(51) Int. Cl. H04N 1/32; G06V 20/52

(52) U.S. Cl. CPC H04N 1/32577; G06V 20/52; H04N 2201/0094

(57) ABSTRACT

“Mobile unit for certifiable digitization of documents” Mobile unit for certifiable digitization of documents characterized by the use of a vehicle (100) to contain in a workspace (101) the elements necessary for secure digitization which follows a certifiable methodology and which takes into account the best possible precautions for the conservation of the originals during the process. These comprise a monitoring IP camera (111), optical readers to record the start and end of the process steps (110-109), and a professional scanner (112) and a GPS (113). Lastly, the vehicle uses an external electrical power supply (116, 103) and an Internet connection (105) distributed to all the devices in the vehicle.

### FIELD OF THE ART

The present invention relates to the field of the digitization of paper documents and in particular in the certification of the digitization process.

### KNOWN ART

In the field of archiving and document management, the transition from physical media to digital media has revolutionized the world of work, allowing to accelerate, make more efficient and make possible a whole series of processes which would be unthinkable with the use of printed paper.

In this transition phenomenon, it became necessary to digitize the previously produced documentary material, preserved in the archives, so that it can be used and archived with the same flexibility as documents created in digital version.

Digitizing means abandoning traditional tools, known as analogue, in order to streamline workflows and automate activities and procedures, whether they are linked to the production and distribution of products and services, to marketing and sales, to customer care, or whether they are related to the scope of document management of administrative, accounting and fiscal material. Digitizing also means dematerializing physical places to communicate and share information in real time, in a single connected and collaborative environment, also remotely. Corporate digitization brings new participatory methods and open workspaces therewith, no longer limited to a particular context at a desk or in the office, but can be shared remotely. Digital document management is capable of offering enormous benefits, such as the complete traceability of information, its integration into internal workflows and external supply chains, greater speed in completing the various activity steps, and last but not least, the reduction of process burdens, including costs for physical storage spaces. Despite this, the digitization process presents critical issues which must be appropriately addressed; in fact, in order for the documents in question to not be accidentally disseminated, stolen against the will of the owners, and retain their legal validity as a true copy of the original, the transition into digital form must occur by means of a certified protocol.

There are currently digitization processes adapted to create certified digital copies, especially in reference to the use of technologies and methodologies which are capable of ensuring the integrity and traceability of a given document, collecting and preserving opposable evidence to third parties of the treatment which the documents receive along the entire digitization chain starting from taking change thereof in the physical archives where they were originally kept.

Among the existing solutions which address such a problem, we can mention patent IT201800010125A1 presenting a certifiable digitization process which, thanks to its high level of quality and security, is capable of ensuring the conformity of digital copies of paper documents. However, the present invention intends to extend the applicability of the certified digitization process to those cases in which a public or private organization does not have adequately equipped headquarters where the digitization process can be carried out, or does not want and/or cannot, due to the nature of the documents to be processed (for example in the case of particularly critical documents from the point of view of confidentiality), entrust the digitization to a specialized external center. In particular, the invention is not limited to operating a complete, secure and certified digitization process, but also solves the problem linked to the transfer of documents to be digitized, as it requires the presence of a mobile unit equipped with all the devices necessary to perform the entire digitization process, which can, as it is mobile, be positioned at the customer's premises and perform all the necessary operations without compromising the security and integrity of the documents of interest, in a possible transfer.

### DESCRIPTION OF THE INVENTION

According to the present invention, a mobile unit for certifiable digitization of documents is created which effectively solves the above problems. In this case, the invention consists of a sufficiently large mobile unit, equipped with everything necessary to perform the certified digitization process of documents originally produced on physical media, by means of a suitable certification protocol, which produces proof of validity of the validity of the digital version of the document which can be presented to third parties. The tools present within such mobile units, used according to a method which will be described in the following, provide a secure and effective certified digitization process.

The scenario in which it is useful to be able to group the digitization work tools in a mobile unit is one in which the nature of the documents is such that it does not allow the transfer thereof to the physical headquarters of the body carrying out the digitization. An example consists of particularly sensitive documents for which the policies used by the customer do not allow entrusting the original copies of the documents to third parties. The possibility of moving the mobile unit near the archives where the documents are kept in paper version minimizes the movement of the latter, which is carried out from the company archiving center to the mobile unit where the documents will be digitized.

Such a mobile unit is created inside a sufficiently large vehicle, comprising at least a protected work environment, with appropriate openings designed to exploit the natural light inside and also equipped with an electrical network adapted to power the various devices, connectable to an external source or to an autonomous supply source such as a fuel generator or a solar panel system placed on the roof of the vehicle. Such devices are also interconnected by means of a LAN network connected to the Internet. The devices which use these networks are divided into two main categories:
devices adapted to carry out the digitization of paper documents, such as scanners or cameras, the central computing unit adapted to record the steps of the process carried out and generate the digital files of the document units;
devices adapted to monitor and certify the digitization of documents such as IP cameras, external surveillance cameras, operator identification systems by means of NFC badges or by means of biometric recognition.

The workspace inside the vehicle is divided into two equipped macro-areas adapted to allow the certified digitization of documents according to the following method.

In the first intelligent station, equipped with a work table monitored by an IP camera and a computing interface by means of which the operator identifies themself, for example by means of an NFC badge or by scanning a biometric parameter, the normalization and preparation of the documents to be scanned is carried out. Here the documents are reordered, checked for the number and orientation of the pages, identified by means of a machine-readable label (barcode or qr code) which defines the specific document unit, and will subsequently signal the beginning and end of the specific file to the scanner. Lastly, the document unit is paired with the accompanying document which collects all the useful information.

In the second intelligent station, equipped with a professional scanner, the actual scanning of the documents is carried out, in order to create a digital file equivalent to the original. The scanning process is also recorded by means of IP cameras and is carried out by an operator who has previously identified himself/herself with the same method as the first step.

At the same time as the creation of the digital file, before sending the latter to the document management system, the DCOM (Documents Consolidation & Organization Module) module associates each digital copy with a specific processing batch based on rules predefined by the process manager in the setup step; they insert a QR Code on each digital copy containing the information: CUC, Batch Code, Document UID, scanning date, and lastly a qualified electronic seal is inserted in order to make the document content non-editable. The initial certification of the processing batches is carried out by the process certifying body (SCP) and consists of verifying the conformity of the copies with respect to the analogue originals using the method of comparison between the original and the digital copy, if non-conformities are detected the digital copy is discarded and the original paper document is re-digitized. Once all copies have been verified, the SCP draws up the initial certification report which will be uploaded to the computer system (CMM). The initial certification step is followed by a final closing check which improves the certification, ending in a drafting and signing of the certificate of conformity, or “verification report”, as long as the checks are successful, or in discarding the entire batch in the opposite case.

The successful closing certification starts the certified conservation steps of all the digitized documents belonging to the specific certified processing batch, in particular the preparation and sending of the deposit packets (PdV) to the certified conservation system and, if contractually foreseen, the transfer of the digitized documents to the customer's document system also occurs, according to the integration methods established in the service contract.

Such a mobile unit can be configured integrated in a road vehicle or even inside a standard transport module such as a container, which is transported and positioned near the archive involved, and subsequently removed at the end of the work. This option allows the flexibility of such a system to be further extended, allowing the use of standardized logistics systems, not limiting the movement to wheeled vehicles but also to trains or ships and the like. This solution also reduces creation costs, allowing the creation of several mobile units moved by a smaller number of vehicles, preventing the unit's engine from remaining idle and unused while the certified digitization work is being carried out.

The advantages offered by the present invention are evident in the light of the description presented thus far and will be even clearer thanks to the attached figures and the related detailed description.

### DESCRIPTION OF THE FIGURES

The invention will be described hereinafter in at least one preferred embodiment by way of non-limiting example with the aid of the appended figures, in which:

FIG. 1 shows the main elements of the mobile unit 100 for certified document digitization. Said system comprises a plurality of devices located in at least one workspace 101 protected with openings 102 for the entry of natural light within which at least one power supply system 116 for devices connected to an external electrical interface 103 are located, a LAN data network 105 with connection to the Internet by means of a 5G antenna 104 adapted to allow data transmission in the Cloud. The two intelligent stations are highlighted: The first 106 dedicated to document normalization and scanning preparation procedures, and characterized by: an all-in-one computer 108, an incoming and outgoing 110 machine-readable optical code reader 109 and an IP camera 111 fixed on an arm attached to the desk and with a view facing the digitization process, i.e., towards the work surface of the desk itself. The second station, used for scanning 107, consists of the same elements as the intelligent station dedicated to normalization 106, except for one of the barcode/qr code readers which is integrated inside a professional scanner 112. The invention envisages, by means of said computer 108 and said network 105, saving and sharing the video recording in the cloud, carried out by means of said IP camera 111, of the operator's actions, which envisages labeling each paper document with adhesive labels 114 and determines the processing start and end using said code readers 109-110. The present figure also illustrates a GPS tracker 113 adapted to certify that the documents have maintained their geographical position during the digitization process. Lastly, the system is characterized by the presence of at least one computing center 115 in a private Cloud for data processing related to the surveillance of the digitization processes and the digital results of the process.

FIG. 2 illustrates the devices adapted to integrate and implement the functionality of said mobile unit for certifiable document digitization. In fact, a plurality of modules used for the security and privacy of the digitization process are depicted. Said modules comprise: a biometric recognition apparatus 400 adapted to authenticate the operators at the entrance of said workplace 101, a VPN 500 to preserve the privacy of Internet network traffic of the data related to the digitized documents and a private satellite data link 900 with said computing center 115 adapted to allow data communication totally isolated from Internet traffic. Said system is integrated by an air humidity sensor 700 connected to a controller 701 which automatically adjusts a dehumidifying and humidifying device 702 adapted to allow an optimal conservation of the original paper documents. Furthermore, the figure illustrates various devices adapted to also ensure the integrity of photosensitive documents, such as: photochromic glasses 602 adapted to maintain a stable level of lighting in the workplace and ambient light sensors 600 adapted to measure and show the operator if the luminosity or UV ray level exceeds a predefined threshold. Said sensors are also connected to a controller 601 which adjusts the internal lighting system. Lastly, said system is characterized by an external power source 200, adapted to provide all the electric power necessary for the operation of the devices on board said electric propulsion vehicle 100, a rechargeable electric accumulator 300, sufficient for the operation of the onboard devices for a time covering at least one working day and a plurality of photovoltaic panels on the roof of the vehicle connected to said power supply system 116 adapted to power the devices during the process.

FIG. 3 depicts a perspective view of the invention in which the temporary containers 116 equipped with electronic labels 117 from which the documents are taken for on-site digitization are also placed in the space. It also shows the positioning of the outer periphery surveillance cameras 1100, which are active 24 hours a day even during internal processing times, and the two internal surveillance cameras 1101 which are dedicated to accesses at unauthorized times and therefore active during periods of absence of operators. In fact, unlike the IP camera mentioned previously, such cameras are not dedicated to monitoring the work carried out by the digitization operators. A redundant data storage apparatus 1000 is also shown, which is adapted to ensure a local backup of the work carried out before the definitive storage on a more reliable Cloud system. Furthermore, for completeness it is shown how there is always a smart-card reader 118 which authenticates the operator in each of the stations. Lastly, air conditioners 703 are shown which integrate temperature control in addition to the humidity control already mentioned.

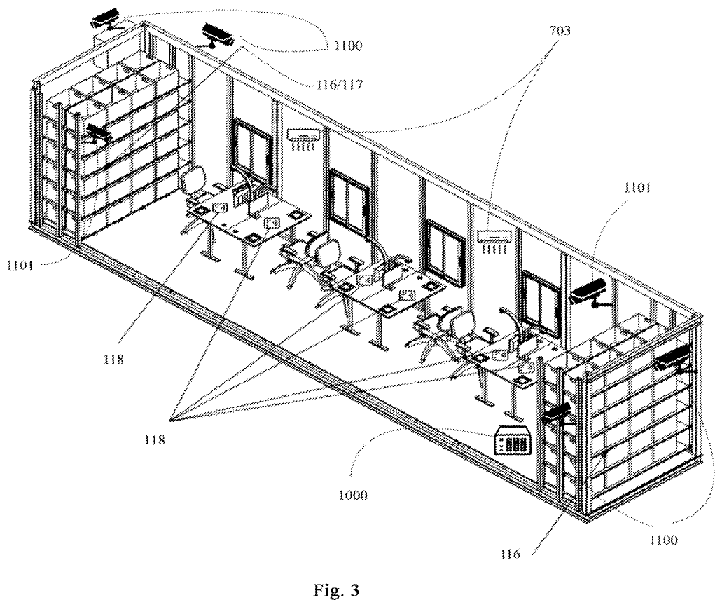

### DETAILED DESCRIPTION OF THE INVENTION

The present invention will now be illustrated by way of a purely non-limiting or binding example, resorting to the figures which illustrate some embodiments with respect to the present inventive concept.

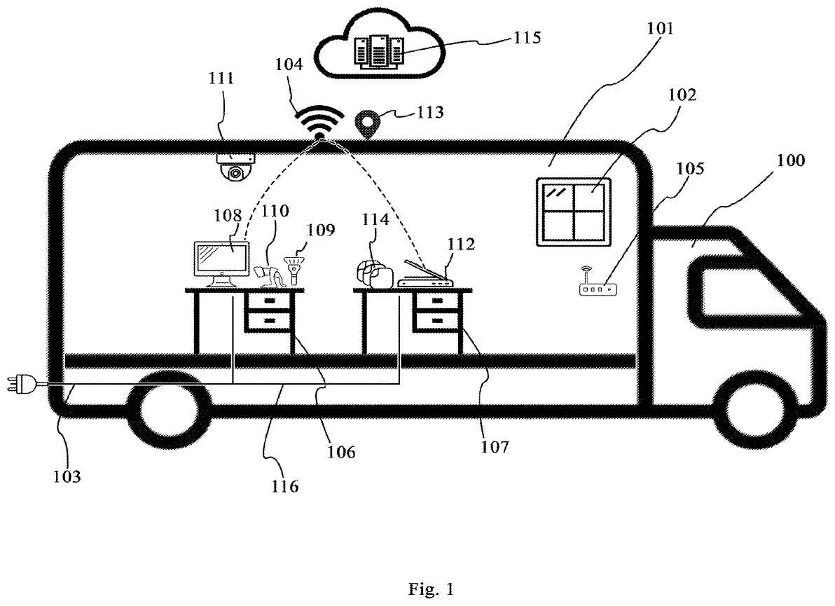

With reference to FIG. 1, the main elements characterizing the mobile unit for certifiable document digitization are illustrated, which is characterized by a plurality of devices placed on a vehicle 100 adapted to generate a digital version of a paper document through a process whose security and compliance can be certified. Said vehicle consists of at least one protected workspace 101 with openings 102 for the entry of natural light inside which a plurality of modules are located which are adapted to ensure the efficiency of said certifiable document digitization process. In fact, the figure illustrates a power supply system 116 for devices connected to an external electrical interface 103 adapted to allow power to be received in the place where said process is carried out, a LAN data network 105 with a connection to the Internet by means of a suitable 5G antenna 104 to instead allow the transmission of data in the Cloud and two intelligent workstations. The first station will be dedicated to the normalization 106 of documents and the procedures for optimal preparation of the paper material for scanning. To allow this, said station is characterized by at least: an all-in-one computer 108 equipped with a multi-touch user interface panel, an optical reader for machine-readable codes 109 in input and one in output 110 and an IP camera 111. The second station, consisting of the same elements as said intelligent station dedicated to normalization 106 and integrated by a professional scanner 112, will instead be used for scanning 107. Said mobile digitization system also has a GPS tracker 113 adapted to certify that the documents have maintained their geographical position during the digitization process. Furthermore, the figure shows a surveillance of the operator saved by means of said computer 108 and said network 105, who, after having labeled each paper document with adhesive labels 114, determines the beginning and end of the processing of each individual file using said code readers 109-110 while the process is recorded by said IP camera 111. Lastly, the system envisages the presence of at least one computing center 115 in a private Cloud which is adapted to process the data related to the surveillance of the digitization processes and process the digital result of the process.

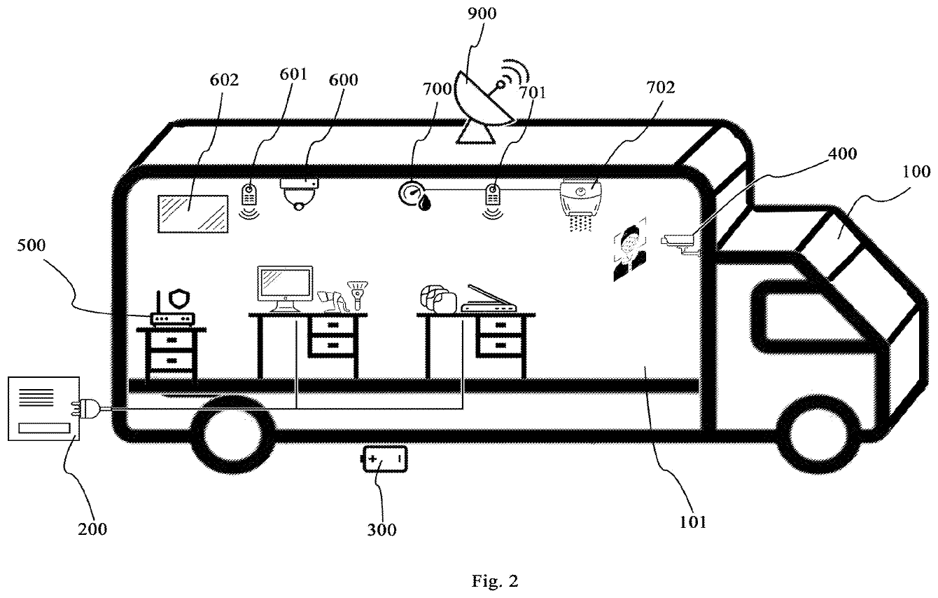

With reference to FIG. 2, the integral elements of said paper document digitization system are illustrated in order to implement the efficiency thereof. The invention envisages a plurality of devices adapted to ensure procedural continuity despite the possible distance from sources of electrical energy. In fact, the present figure illustrates an external power source 200, adapted to provide all the electric power necessary for the operation of the devices on board said electric propulsion vehicle 100, a rechargeable electric accumulator 300 both through common electrical sockets and by common electric vehicle charging systems, sufficient for the operation of the onboard devices for a time covering at least one working day and finally a plurality of photovoltaic panels on the roof of the vehicle connected to said power supply system 116 adapted to power the devices during the process. The residual autonomy of the support batteries is in any case monitored so as to communicate the need for recharging.

Said system further envisages a plurality of modules dedicated to security and privacy during the digitization process. In fact, the invention comprises a biometric recognition apparatus 400 adapted to authenticate the operators at the entrance of said workplace 101, a VPN 500 to preserve the privacy of Internet network traffic of the data related to the digitized documents and a private satellite data link 900 with said computing center 115 adapted to allow data communication totally isolated from Internet traffic. In order to ensure the integrity of delicate photosensitive documents, said system comprises photochromic glasses 602 adapted to maintain a stable level of lighting in the workplace and ambient light sensors 600 adapted to measure and show the operator if the luminosity or UV ray level exceeds a predefined threshold. Said sensors are also connected to a controller 601 which adjusts the internal lighting system to determine the level of light irradiation in said workspace. Lastly, the present figure illustrates an air humidity sensor 700 connected to a controller 701 which automatically adjusts a dehumidifying and humidifying device 702 adapted to allow an optimal conservation of the original paper documents. Furthermore, there is an external 1100 and internal 1101 video surveillance system dedicated to monitoring access at unauthorized times; such a system will be arranged to be fully operational when connected to the electricity supply network or alternatively it will be powered by the internal energy systems.

Finally, it is clear that modifications, additions or variations that are obvious to a person skilled in the art can be made to the invention described so far, without thereby departing from the scope of protection provided by the attached claims.

1. Mobile unit for a certifiable digitization of documents, characterized in that by means of devices arranged on a vehicle (100) it allows to obtain a replacement digital copy generated by a process whose safety and compliance can be attested; wherein said vehicle comprises at least a protected workspace (101) with openings (102) for entry of natural light and inside which at least the following is provided:
a. a power supply system (116) for the devices, which is connected to an external electrical interface (103) allowing to receive electrical power in the place where the digitization process is carried out;
b. a LAN data network (105) with a connection to the Internet via a 4G or 5G antenna (104), depending on signal coverage, adapted for cloud data transmission;
c. two different types of intelligent workstations:
i. a first one (106) dedicated to a normalization/standardization of the documents, devoted to procedures for optimal preparation of paper documents to be used during scanning, this workstation comprising in turn: an all-in-one computer (108), an entry (109) optical reader of machine-readable codes and an exit (110) optical reader for machine-readable codes (110), a smart card reader for operator identification (118), an IP camera (111) devoted to the surveillance of the process;
ii. a second one (107) dedicated to a scanning operation, comprising the same elements as in said intelligent workstation dedicated to the normalization/standardization (106), and also a professional scanner (112);
d. a GPS tracker (113) adapted for certifying that the documents did not change their geographical position during the digitization process;
e. a temporary storage system of paper documents in containers (116) with digital tags (117) adapted for identifying the documents contained therein;
this system including a video surveillance of the operator by means of said IP camera (111), recorded by means of said computer (108) and said network (105), wherein said operator, after labeling each paper document with adhesive labels (114), determines/defines the beginning and the end of the process using said code readers (109)(110); said system also including at least one private cloud computing center (115) adapted for processing the data related to the surveillance of the digitization processes and for providing a digital result of this process.

2. Mobile unit for a certifiable digitization of documents, according to claim 1, characterized in that it comprises an external power source (200) adapted for providing the whole electric power necessary to the operation of the devices installed in said vehicle (100).

3. Mobile unit for a certifiable digitization of documents, according to claim 1, characterized in that said vehicle is electrically powered and is equipped with an electric accumulator (300) which suffices for the operation of the onboard devices, for a time covering at least one working day; wherein said accumulator is rechargeable by means of common electric outlets or common charging stations for electric vehicles.

4. Mobile unit for a certifiable digitization of documents, according to claim 1, characterized in that it comprises an identification system at the entrance to the mobile unit, which uses at least one biometric recognition apparatus (400) adapted for authenticating operators allowed to enter in the workplace (101).

5. Mobile unit for a certifiable digitization of documents, according to claim 1, characterized in that it comprises a VPN network (500) to preserve the privacy of the traffic on the internet of the data concerning the digitized documents.

6. Mobile unit for a certifiable digitization of documents, according to claim 1, characterized in that it insures the integrity of delicate photo-sensitive documents thanks to an ambient light sensor (600) adapted for measuring and showing to an operator if the luminosity or the UV ray level exceeds a predefined threshold; said sensors being also connected to a controller (601) that controls an internal illumination system in order to determine its light radiation level in the workplace (101); said system also including photochromic glasses (602) for preserving the constancy of the illumination level in the workplace.

7. Mobile unit for a certifiable digitization of documents, according to claim 1, characterized in that it comprises at least one air humidity sensor (700) and a thermometer, connected to a controller (701) that automatically controls/adjusts a dehumidifying and humidifying device (702) and a temperature conditioner (703), all of which adapted for preserving optimal conditions for the preservation of the state of the original paper documents.

8. Mobile unit for a certifiable digitization of documents, according to claim 1, characterized in that it comprises on the vehicle roof a plurality of photovoltaic panels connected with said power supply system (116) and adapted for power supplying the devices during the process.

9. Mobile unit for a certifiable digitization of documents, according to claim 1, characterized in that it comprises a private satellite data link (900) to said computing center (115), for allowing a data communication totally isolated from the internet traffic.

10. Mobile unit for a certifiable digitization of documents, according to claim 1, characterized in that it comprises a video surveillance system along the outer periphery (1100) and in the interior (1101) of said mobile unit.

11. Mobile unit for a certifiable digitization of documents, according to claim 1, characterized in that the workplace (101) forms a logistic module which is separable/detachable from the vehicle (100), for instance a cargo/container.

12. Method of certified digitization of documents characterized in that it uses said mobile unit according to claim 1 and in that it comprises the following steps:
a. at the first workstation (106), the paper documents are normalized/standardized and prepared for scanning, by removing clips or the like, by checking the page order and their orientation, and at the same time a machine-readable barcode or QR code is assigned to each page which uniquely identifies the document unit in question, while an accompanying document is generated for each individual file;
b. at the second workstation (107) the paper document is scanned and the images so obtained are optimized, so as to create the digital file of the document;
c. the digital file is equipped with a QR Code containing the following information: CUC code, batch code, unique identifier UID of the document, scanning date, and finally a qualified electronic seal is inserted in order to make the document content unmodifiable/non-editable;
d. an initial certification of the processed batches is performed by the process certifier, which consists in the verification of conformity between the copies and their analogue originals, by employing a comparison method between the original and the digital copy;
e. a final check is carried out to improve the certification, ending in a drafting and signing of the certificate of conformity, referenced to as “verification report”, provided that the checks are successful, or in discarding the entire batch in the opposite case.

13. Method of certified digitization of documents according to claim 12, characterized in that all operations carried out inside the mobile unit (100) are monitored and recorded by IP cameras in order to generate evidence that can be challenged against third parties, for what concerns the certification process.
